(19) United States
(12) Patent Application Publication
(10) Pub. No.: US 2022/0202644 A1
(43) Pub. Date: Jun. 30, 2022

(54) Clogged Duct Massager

(71) Applicants: Lindsay Lowe, San Juan Capistrano, CA (US); Jennifer McCann, San Clemente, CA (US)

(72) Inventors: Lindsay Lowe, San Juan Capistrano, CA (US); Jennifer McCann, San Clemente, CA (US)

(21) Appl. No.: 17/561,229

(22) Filed: Dec. 23, 2021

Related U.S. Application Data
(60) Provisional application No. 63/131,525, filed on Dec. 29, 2020.

(51) Int. Cl. A61H 15/02; A61H 15/00; A61H 23/02

(52) U.S. Cl. CPC A61H 15/02; A61H 15/0092; A61H 23/02; A61H 2201/0153; A61H 2201/0207; A61H 2201/1207; A61H 2015/0071; A61H 2201/1695; A61H 2201/5038; A61H 2205/082; A61H 2015/0014

(57) ABSTRACT

A clogged duct massager includes a handle, a pair of arms each affixed at. a lower end to an upper end of the handle, and a massage roller having opposing sides that rotatably connect to the upper end of each arm, such that the massage roller is freely rotatable between the pair of arms. A power supply disposed within the handle is operably connected to a heating element and a vibration motor disposed within the massage roller. Temperature and vibration controls disposed on the handle allow the user to selectively activate or deactivate the heating element and the vibration motor. The massage roller pressure, heat, and vibration can be applied to any desired area of the skin in order to prevent and alleviate clogging of ducts and pores, thereby helping to prevent mastitis and other negative conditions associated with dogged ducts and pores.

### CROSS-REFERENCE TO RELATED APPLICATIONS

This application claims the benefit of U.S. Provisional Application No. 63/131,525 filed on Dec. 29, 2020. The above identified patent application is herein incorporated by reference in its entirety to provide continuity of disclosure.

### BACKGROUND OF THE INVENTION

The present invention relates to a handheld massager. More specifically, the present invention provides a dogged duct massager that is utilized to apply massage roller pressure, vibration, and heat to desired areas of the body in order to prevent and alleviate mastitis and other issues associated with clogged ducts or pores.

The human body includes thousands upon thousands of small ducts and pores. Particularly when breastfeeding, individuals may develop a condition called mastitis, the symptoms of which includes inflamed and sore breast tissue caused by clogged milk ducts. Mastitis can be very painful if not properly treated, and even when treated there will be some amount of unwanted pain while the individual recovers. Other issues may arise from clogged skin pores. When dead skin cells and other particles are trapped within the pores, it can cause swelling, pain, pimples, and other unwanted symptoms. One way to alleviate clogged ducts and pares is to massage the affected area. The massaging pressure can help relax the tissue and allow any trapped material to escape. The massaging pressure can also help to alleviate the pain associated with clogged milk ducts and mastitis specifically. However, massaging pressure is not always enough to sufficiently reduce the pain and alleviate the symptoms, individuals may also wish to apply heat to the area with a heating pad or similar device, but this can be difficult while also massaging the affected area. In order to address these concerns, the present invention provides a clogged duct massager that includes a massage roller with both a vibration motor and a heating element. This allows individuals to apply a combination of massage pressure, vibration, and heat to the affected area, in order to alleviate the symptoms of mastitis and other issues caused by clogged ducts or pores more quickly and more effectively.

Devices have been disclosed in the known art that relate to massage rollers. These include devices that have been patented and disclosed in patent application publications. However, the devices in the known art have several drawbacks. For example, the devices in the known art are typically unpowered and utilize only massage pressure without additional elements. Other devices include either heat or vibration elements, but no devices employ the combination of massage pressure, heat, and vibration to vastly improve the effectiveness of the massage roller. Such devices further lack an effective means for powering with a rechargeable battery supply that, can include a USB connection or other connector for powering the device.

In light of the devices disclosed in the known art, it is submitted that the present invention substantially diverges in design elements from the known art and consequently it is clear that, there is a need in the art for an improvement to existing massage devices, particularly with regard to the above-described need for a massage device having a combination of massage roller pressure, heat, and vibration, for the general purpose of alleviating the symptoms of mastitis and other issues caused by clogged ducts and pores. In this regard the present invention substantially fulfills these needs.

### SUMMARY OF THE INVENTION

The present invention provides a clogged duct massager wherein the same can be utilized for applying massage pressure, heat, and vibration to an area having clogged duct or pores in order to alleviate the symptoms thereof. The clogged duct massager with armrest clips generally includes a handle, a pair of arms each affixed at a lower end to an upper end of the handle, and a massage roller having opposing sides that rotatably connect to the upper end of each arm, such that the massage roller is freely rotatable between the pair of arms. A power supply disposed within the handle powers a heating element disposed within the massage roller and a vibration motor disposed within the massage roller. A temperature control disposed on the handle is operably connected to the heating element via a control circuit, wherein the temperature control is configured to selectively activate or deactivate the heating element. A vibration motor control disposed on the handle is operably connected to the heating element via the control circuit, wherein the vibration motor control is configured to selectively activate or deactivate the vibration motor. The massage roller pressure, heating element, and vibration motor can be utilized in combination when applied to a clogged duct or pore, in order to help unclog the duct or pore and relieve symptoms caused by the duct, or pore being clogged.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the clogged duct massager.

FIG. 2 shows a front elevation view of an embodiment of the clogged duct massager.

FIG. 3 shows a side elevation view of an embodiment of the dogged duct massager,

FIG. 4 shows a perspective view of an embodiment of the clogged duct massager in use.

FIG. 5 shows a block diagram of the electronic components of an embodiment of the clogged duct massager.

### DETAILED DESCRIPTION OF THE INVENTION

Reference is made herein to the attached drawings. Like reference numerals are used throughout the drawings to depict like or similar elements of the clogged duct massager. For the purposes of presenting a brief and clear description of the present invention, 3 preferred embodiment will be discussed as used for applying pressure, heat, and vibration to an area of the body to alleviate and prevent clogged ducts and pores.

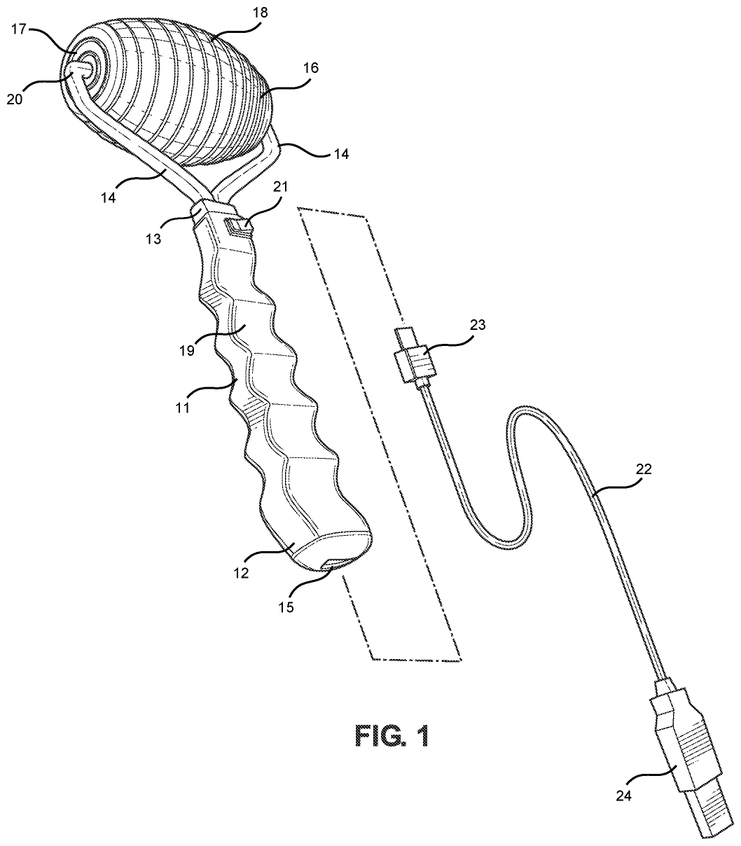

Referring now to FIG. 1, there is shown a perspective view of an embodiment of the clogged duct massager. The clogged duct massager includes 3 handle 11 that is grasped by the user. In the shown embodiment, the handle 11 includes finger indents 19 that receive the user's fingers, allowing for a more comfortable grip when using the clogged duct massager. A pair of arms 14 are affixed to an upper end 13 of the handle 11. The pair of arms 14 extend upwardly and outwardly from the upper end 13 of the handle 11 before curving inwardly to connect, to opposing sides 17 of a massage roller 16. The opposing planar sides 17 of the massage roller 16 are rotatably connected to upper ends 20 of each arm 14, allowing the massage roller 16 to freely rotate along the user's body as the user applies pressure via the massage roller 16 and handle 11.

In the shown embodiment, the massage roller 16 includes a prolate spheroid shape with a width that decreases toward each opposing side 17. The configuration allows users to adjust the pressure they apply by pivoting the massage roller 16 along its lengthwise axis during use. In other embodiments, the massage roller 16 can include other shapes, such as spherical, for example. Further, in the shown embodiment, the massage roller 16 includes a plurality of spaced circumferential ridges 18. The ridges 18 provide additional pressure points and help to effectively massage the user when the device is in use. in other embodiments, the massage roller 16 can include different textured surfaces or patterns.

A power supply is disposed within the handle 11. The power supply powers the electronic components of the massager, which includes a vibration motor and a heating element, operably connected to the power supply. At least one control 21 is disposed on the handle 11 for controlling the vibration motor and heating element. In the shown embodiment, the lower end 12. of the handle 11 includes a charging port 15 that operably connects to the internal power supply, which may be a rechargeable battery. The charging port 15 is a USB port in the shown embodiment, but other types of ports may be utilized. The charging port 15 can receive a connector 23 of a charging cable 22, the opposing connector 24 of which can connect to an external energy source such as a wall outlet or the like for charging the internal power supply.

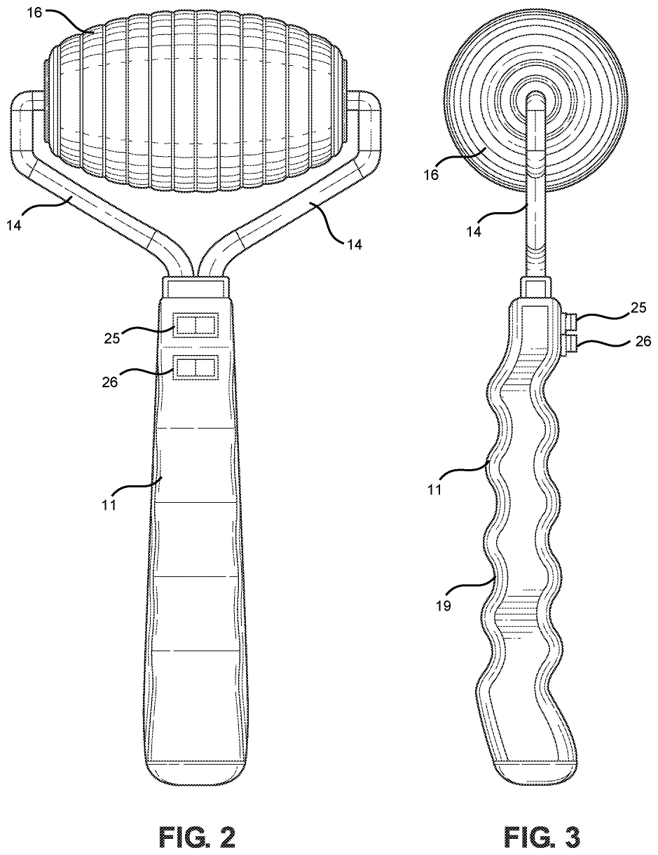

Referring now to FIGS. 2 and 3, there are shown front and side elevation views of an embodiment of the clogged duct massager. In the embodiment show in FIG. 2, the massager includes individual temperature controls 25 and vibration controls 26. This allows the user to apply either one of or both features independently or together as desired, providing greater user control. In the shown embodiment, the temperature control 25 and vibration control 26 are on/off switches. However, any suitable control mechanisms may be included, such as buttons, touchscreens, or the like. Further, some embodiments may include temperature range controls that allow the user to adjust the maximum temperature of the device. Such a control may be 3 rotatable dial, a digital readout with buttons, a touchscreen display, or any other suitable user control mechanism that can receive an input from a user. Similarly, some embodiments may include vibration intensity controls that allow the user to select the intensity of the vibration motor, thereby adding further user control to the massager.

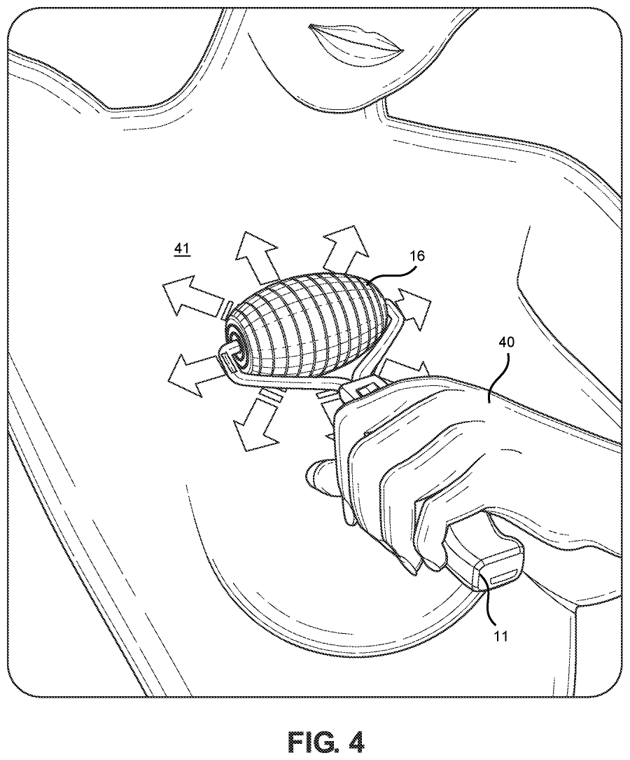

Referring now to FIG. 4, there is shown a perspective view of an embodiment of the dogged duct massager in use. In operation, the user 40 can grasp the handle 11 and apply the massage roller to the desired area of the body 41. In the shown example, the user 40 is massaging an area of the breast that is affected by clogged ducts. The shape of the massage roller 16 allows the user to apply pressure easily and effectively in all directions as it rolls, thereby softening and soothing the clogged ducts. The user can also selectively apply heat, or vibration pressure to further soothe the affected area. In some embodiments, the present invention includes a waterproof housing, which may include specific waterproof materials, seals, and the like, in order to allow safe operation in the shower or other similar environments.

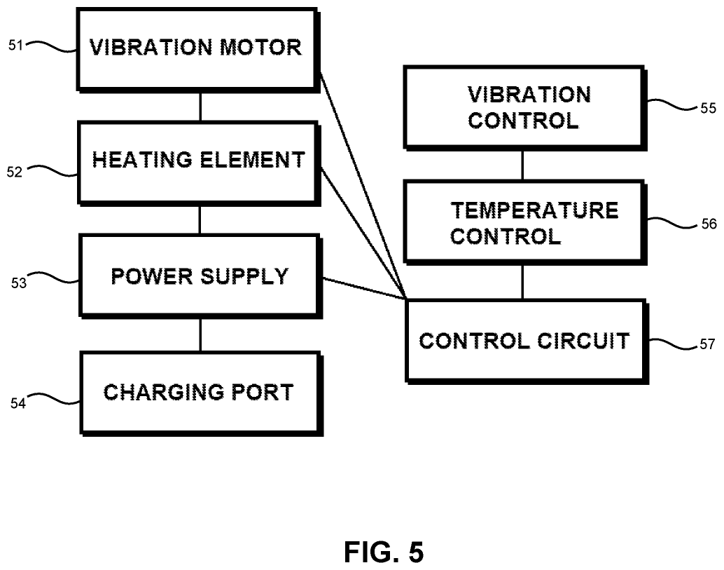

Referring now to FIG. 5, there is shown a block diagram of the electronic components of an embodiment of the dogged duct massager. The power supply 53, which is typically a rechargeable battery, is operably connected to the charging port 54 for receiving electrical energy from an energy source for charging purposes. The vibration motor 51, heating element 52, and power supply 53 are all operably connected to a control circuit 57 that controls the operation of the device's electrical components. The control circuit 57 may include analog and digital circuit elements. For example, the control circuit 57 may simply be utilized to activate or deactivate the heating element 52 and vibration motor 53, or may be configured to provide additional control by setting 3 precise temperature for the heating element 52 or a precise intensity for the vibration motor 53.

The control circuit 57 is operably connected to the temperature control 55 and the vibration control 56 disposed on the massager's handle. The temperature control 55 is configured to selectively activate or deactivate the heating element 52, and the vibration control 56 is configured to selectively activate or deactivate the vibration motor 51. In some embodiments, these controls allow further customization of the temperature of the heating element 52 and the intensity of the vibration motor 51. For example, the temperature control 55 may include a 3-way toggle switch that allows the user to select between three levels of heat intensity, in another embodiment, the temperature control 55 may include a display that indicates current temperature settings and one or more buttons that allow the user to scroll and select a more precise temperature. Similarly, the vibration controls 56 can also include toggle switches, displays, and the like for fine tuning the vibration application. In this way, the present invention can be utilized to effectively apply pressure, vibration, and heat to an area with clogged milk ducts or other areas of the body to alleviate mastitis and other issues associated with dogged ducts and pores.

It is therefore submitted that the present invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, and all equivalent relationships to those illustrated in the drawings and described in the specification are intended to be encompassed by the present invention.

The foregoing is considered as illustrative only of the principles of the invention. Further, it is not desired to limit the invention to the exact construction and operation shown and described, and accordingly, all suitable modifications and equivalents may be resorted to, falling within the scope of the invention.

I claim:

1. A clogged duct, massager comprising:
a handle;
a pair of arms each affixed at a lower end to an upper end of the handle;
a massage roller having opposing sides that rotatably connect to the upper end of each arm,
such that the massage roller is freely rotatable between the pair of arms;
a power supply disposed within the handle;
a heating element disposed within the massage roller and operably connected to the power supply;
a vibration motor disposed within the massage roller and operably connected to the power supply;
a temperature control disposed on the handle that is operably connected to the heating element via a control circuit, wherein the temperature control is configured to selectively activate or deactivate the heating element; and
a vibration motor control disposed on the handle that is operably connected to the heating element via the control circuit, wherein the vibration motor control is configured to selectively activate or deactivate the vibration motor.

2. The clogged duct massager of claim 1, further comprising a charging port disposed on a lower end of the handle, the charging port operably connected to the power supply.

3. The clogged duct massager of claim 2, wherein the power supply is a rechargeable battery disposed within the handle.

4. The clogged duct massager of claim 2, wherein the charging port comprises a USB port.

5. The clogged duct massager of claim 1, wherein the handle comprises a plurality of finger indents.

6. The clogged duct massager of claim 1, wherein the massage roller comprises a prolate spheroid shape.

7. The clogged duct massager of claim 6, wherein the massage roller comprises a plurality of circumferential ridges.

8. The clogged duct massager of claim 6, wherein an upper end of each arm is rotatably connected to an opposing planar side of the massage roller.

9. The clogged duct massager of claim 1, wherein the temperature control is configured to receive a temperature input from a user.

10. The clogged duct massager of claim 1, wherein the vibration control is configured to receive a vibration intensity input from a user.
